(19) United States
(12) Patent Application Publication
(10) Pub. No.: US 2004/0244033 A1
(43) Pub. Date: Dec. 2, 2004

(54) Multi-format digital video fiber-optic link

(76) Inventors: Norman Ostensoe, Oxnard, CA (US); Sridevi Rao, Thousand Oaks, CA (US); Andrew Osmond, Westlake Village, CA (US)

Correspondence Address: TROJAN LAW OFFICES, 9250 WILSHIRE BLVD, SUITE 325, BEVERLY HILLS, CA, 90212

(21) Appl. No.: 10/819,477

(22) Filed: Apr. 6, 2004

Related U.S. Application Data
(60) Provisional application No. 60/461,536, filed on Apr. 7, 2003.

(51) Int. Cl. H04N 7/16; H04N 7/173

(52) U.S. Cl. 725/25; 725/30

(57) ABSTRACT

A multi-format fiber-optic link for transporting digital video, digital audio, analog video, and analog audio signals that are locked to regulatory tariffs or service rates. A standard transmitter provides SDI and ASI inputs that are selected by a tariff select control circuit that locks the output to a particular tariff or regulatory rate. In a more complex transmitter encoder, multiple audio inputs are provided through an AES audio receiver and an analog digital converter through an audio A/B select circuit. Digital and analog video are provided through an SDI/ASI video receiver and an analog to digital converter to a video A/B selector circuit. The audio A/B select circuit and video A/B select circuits are locked to particular tariff rates by a tariff select control circuit. The tariff select control circuit is activated via an external multi-way switch or by software computer control through a microprocessor. Both transmitter encoder circuits can lock the outputs to particular tariff rates in up to eight different modes.

Priority of Provisional Application Serial No. 60/461,536, filed Apr. 7, 2003, is hereby claimed.

### BACKGROUND OF THE INVENTION

1. Field of the Invention

This invention relates to multi-format fiber-optic link for transporting digital video, digital audio, analog video, and analog audio signals,and more particularly relates to a multi-format fiber-optic link that is multi-functional and can selectively handle the transportation of digital video, SDI and ASI digital formats and AES digital audio format, analog video, NTSC format and analog audio format locked to a particular tariff or service rate.

2. Background Information

In the United States, professional video is usually transported in metropolitan area networks by telephone companies. These companies are regulated by state Public Utility Commissions (PUC) or the Federal Communications Commission (FCC) and when they offer a product for service for sale, they must first file with these agencies for approval. The filing has to be very detailed technically and provide a financial description of the service. Once filed and approved, the service becomes a tariff or rate service and if the service provider such as a telephone company deviates from the approved rate in any way, they are subject to fines.

Because many video services look similar but are radically different in scope and value, the service provider such as the telephone company would benefit for being able to control the services being provided according to the tariff or approved service rate. The benefit could accrue in several ways. First they could force compliance to the letter of the tariff or rates under which they are providing service thereby avoiding possible legal liability for deviating from the approved rates. Second, they could enhance their revenue by insuring they are correctly paid for all the services that customers want to use.

It is therefore one object of the present invention to provide a multi-function digital video fiber-optic link that can be programmed manually or by computer interface into several different modes exactly matching the regulatory rates or tariff for the service being provided.

Another object of the present invention is to provide a multi-function video fiber-optic link designed for telecommunications service providers with controls to match a customer's link usage to the particular approved rate or tariff.

Yet another object of the present invention is to provide a versatile multi-format video fiber-optic link that can manually select the service provided to a customer that is locked to the rate or tariff.

Still another object of the present invention is to provide a versatile multi-format video fiber-optic link that is programmable through software by a computer interface into several different output modes, each exactly matching the regulatory rates or tariff service provided to the customer.

Still another object of the present invention is to provide a multi-format video fiber-optic link for transporting signals that can provide a rate or tariff locks electively for one of eight modes. These modes can be serial digital interface format (SDI), asynchronous serial interface format (ASI), audio engineering society professional digital audio format (AES), national television standards committee format (NTSC), analog audio format, or combinations of these formats.

Yet another object of the present invention is to provide a front panel display that indicates the digital video format being transported by equipment that provides non-intrusive signal format monitor. This facility allows a service provider to monitor and link format uses without intercepting the traffic when passing a telecommunications central office.

### BRIEF DESCRIPTION OF THE INVENTION

The purpose of the present invention is to provide a multi-mode fiber-optic link combining multiple digital video links with either analog or digital audio all on a single chassis that allows manual or remote selection of modes locked to the service rate or tariff.

Two different multi-mode fiber-optic link transporters are provided. A standard encoder provides tariff locking by either computer control or a manual selector switch control of SDI (Serial Digital Interface) or ASI (Asynchronous Serial Interface) or both modes simultaneously. Digital video in either of these modes is received and fed through a video receiver for output to an A/B select circuit. The select circuit is operated by either a manual external multi-function switch or by computer interface through a microprocessor controller. The multi-function switch and computer interface are connected to a tariff control circuit that provides an output to the A/B select circuit. The output provided by the tariff select control activates the A/B select circuit to select either a SDI or ASI output to a clock, data recovery and general manager circuit.

The clock, data recovery and general manager circuit output is then processed through a multi-plexer, error manager, scrambler, and alarm processing circuit for output to a re-clocker, serializer, laser driver circuit. The laser driver circuit provides either on an ASI or SDI electrical output and an optical output to a laser transmitter. The laser transmitter provides an optical ASI or SDI output as well as an optical level output.

A second embodiment provides a more complex transmitter encoder that is highly versatile multi-format video/audio fiber-optic link combining NTSC, SDI, or ASI video with the analog or digital audio all on a single chassis. Each transmitter encoder can be switched between analog or digital video and is capable of carrying two AES format or four analog format audio signals along with an SDI video stream and analog audio with the analog video signal. The transmitter encoder can be configured for any of the above services and has been specifically designed with fixed rate or tariff structures in mind so the transmitter can be locked to insure only the required tariff rate service is available to the customer.

The transmitter encoder provides an AES (Audio Engineering Society) format audio receiver that can receive two digital audio AES signals. An analog to digital converter also receives a pair of analog audio signals. The AES audio receiver and analog to digital converter provide output to an A/B select circuit.

Also included is an SDI/ASI video receiver receiving digital video in both the SDI and ASI formats. A video analog to digital converter is provided that receives an analog video signal in NTSC format. The video analog to digital converter and SDI/ASI receivers provide outputs to a second A/B select circuit.

The audio A/B select circuit provides an output to a clock and data recovery and sample rate converter circuit. The video A/B select circuit provides an output for clock and data recovery, and a jitter manager circuit. When in the SDI mode, the transmitter removes access timing and alignment jitter from the SDI signal thereby cleaning up feeds with high jitter and permitting error-free multiple cascades.

The audio signal from the clock data recovery sample rater converter circuits and video from the clock and data recovery and jitter manager circuits is then fed to multiplexer, error manager, scrambler and alarm processing circuits. The latter circuits provide an output to a laser driver circuit including a re-clocker and serializer. The laser driver circuit provides an ASI/SDI electrical output to a laser transmitter to provide ASI/SDI optical output as well as an optical level output.

The audio A/B select switching circuit and video A/B select switching circuits are activated through an external multi-way switch and tariff select control circuit or by a computer interface through a microprocessor controller. The tariff select control circuit provides an output to the audio A/B select circuit and/or video A/B select circuit to select one of up to eight different modes.

The modes that can be selected are NTSC and analog audio; SDI; SDI and analog audio; SDI and AES; SDI and ASI; SDI, ASI and analog audio; SDI, ASI and AES; and NTSC and analog audio combined with SDI and ASI. These multi-modes are determined by the tariff select control circuit that locks the particular mode selected to the regulated tariff rate.

Other objects, advantages, and novel features of the invention will become apparent from the following detailed description when considered in conjunction with the accompanying drawings where in like reference numbers and identifying like parts throughout.

### BRIEF DESCRIPTION OF THE DRAWINGS

FIG. 1 is a schematic block diagram of a standard transmitter encoder multi-function fiber-optic link for tariff locking to a selected SDI or ASI output.

FIG. 2 is a schematic block diagram of a more complex transmitter for a multi-mode fiber-optic link for selecting up to eight different modes locked to regulatory tariff rates.

FIG. 3 is a flow diagram of a program illustrating the computer flow control to remotely select modes of the transmitter encoder of FIG. 2.

FIG. 4 is a chart illustrating the multi-modes that can be selected to match the tariff providing a tariff lock.

### DETAILED DESCRIPTION OF THE INVENTION

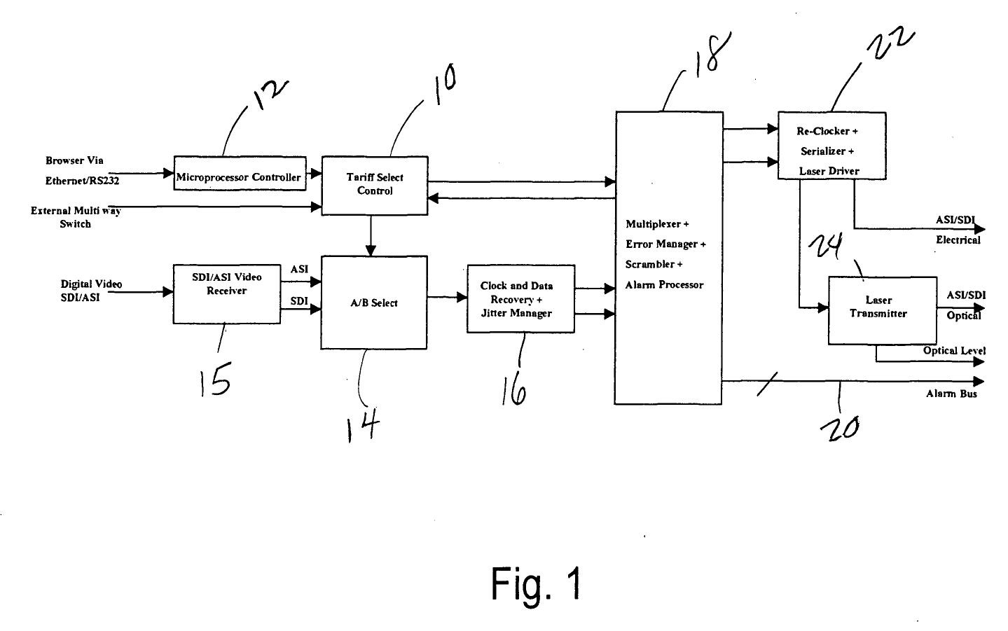

A versatile multi-format digital video fiber-optic link that handles serial digital interface format (SDI) and asynchronous serial interface format (ASI) selectable through an external multi-way switch or by remote computer control through software is illustrated in FIG. 1. The priority of the manual/computer control is assigned via the computer control software. The standard multi-function digital fiber-optic link transmitter encoder has a unique tariff select control 10 for locking the output to the tariff or regulatory rates receiving an input from the microprocessor 12 from software via a browser and Ethernet/RS232 connection. Tariff select control 10 also receives an input from an external multi-way switch that selects the output mode locked to the particular tariff or rate.

The output from tariff select control 10 activates A/B select switching circuit 14. A/B select switching circuit 14 selects an output of either a serial digital interface (SDI) format or an asynchronous serial interface (ASI) format received by video receiver 15. The A/B select switching circuit 14 then provides an output to a clock and data recovery and jitter manager circuit 16. When in SDI mode, jitter manager circuit 16 removes access timing and alignment jitter from the signal cleaning up feeds with high jitter and permitting error-free multiple cascades.

The output from clock and data recovery and jitter manager circuit 16 is then fed to multiplexer, error management, scrambler and alarm processing circuit 18. The alarm processor and other circuits provide an output to alarm bus 20 that will activate a laser alarm LED on a front panel (not shown). The multiplexer, error management, and scrambler circuit also provides outputs to laser driver, reclocker/serializer circuit 22. Laser driver circuit 22 provides an electrical ASI/SDI output as well as an optical output to laser transmitter 24. Laser transmitter 24 then provides an optical ASI/SDI output and an optical level output locked to the regulated tariff.

The transmitter encoder circuit of FIG. 1 provides a tariff lock select control 10 that is designed with fixed regulatory tariff structures in mind so the circuit can be locked to insure only the regulatory rates tariff or tariff servers are available to the customer.

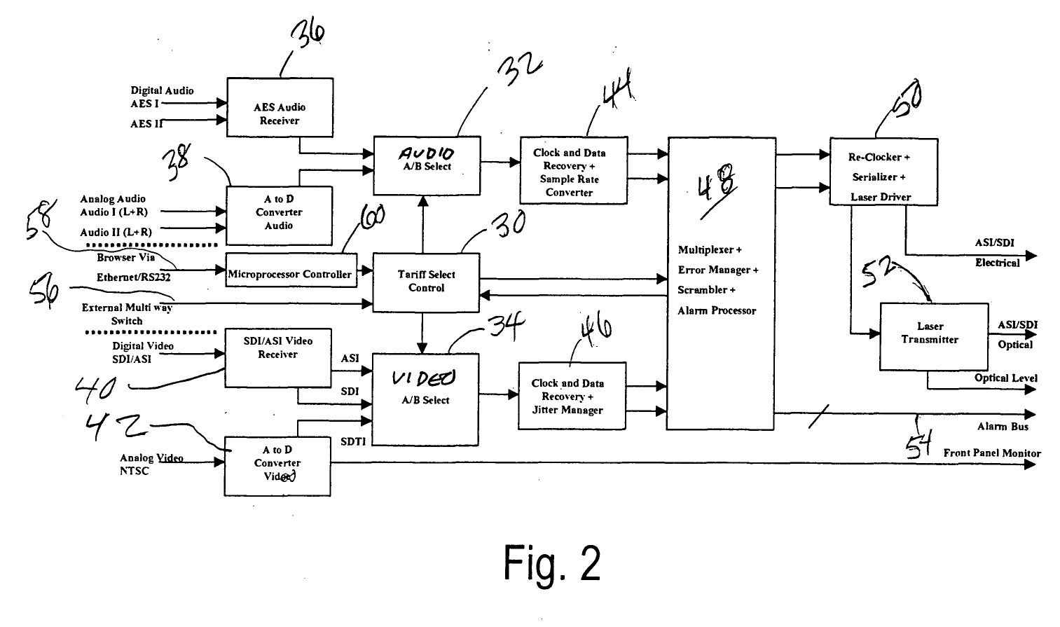

A more complex transmitter encoder is illustrated in FIG. 2. This transmitter encoder allows up to eight different modes locked to regulatory tariffs to be selected. A tariff select control circuit 30 controls the output modes by operating audio A/B select circuit 32 and/or video A/B select circuit 34. Audio A/B select circuit receives inputs from AES audio receiver 36 and analog to digital audio converter 38. AES audio receiver can receive two audio inputs in AES format indicated as AES I and AES II. Likewise analog to digital audio converter 38 can receive two audio inputs indicated as Audio I and Audio II.

Video A/B select switching circuit 34 receives inputs from digital video SDI/ASI video receiver 40 and analog to video NTSC video converter 42. Analog to digital converter video converter 42 converts NTSC analog video to SDTI for input into video A/B select circuit 34 which also receives ASI and SDI inputs from SDI/ASI video receiver 40. The output from audio A/B select circuit 32 is received by clock, data recovery and sample rate converter 44 providing a pair of outputs to a multiplexer, error manager, scrambler and alarm processing circuit 48. Video A/B select circuit 34 provides an output to clock and data recovery and jitter manager circuit 47 providing a pair of outputs to multiplexer error manager scrambler alarm processing circuit 48. Multiplexer, error manager, scrambler and alarm processing circuit 48 provides outputs to reclockers/serializer laser driver 50 that are selected by tariff select control circuit 30. The outputs from reclocker/serializer laser driver are an ASI/DSI electrical output as well as an optical output to a laser transmitter 52. Laser transmitter 52 provides ASI/SDI optical and optical level outputs. An output on alarm bus 54 activates an alarm front panel LED indicator (not shown).

The outputs from the transmitter encoder of FIG. 2 are locked to a particular regulatory tariff or service rate selected by tariff select control 30 which is activated via external multi-way switch 56 and computer control input 58 from a browser via an Ethernet/RS232 connection. The computer control input 58 is fed through microprocessor controller (CPU) 60 that activates the tariff select control circuit 30 to select a particular service locked to the regulatory tariff.

The tariff locking can be controlled either by external multi-way switch 56 or via software control program input 58.

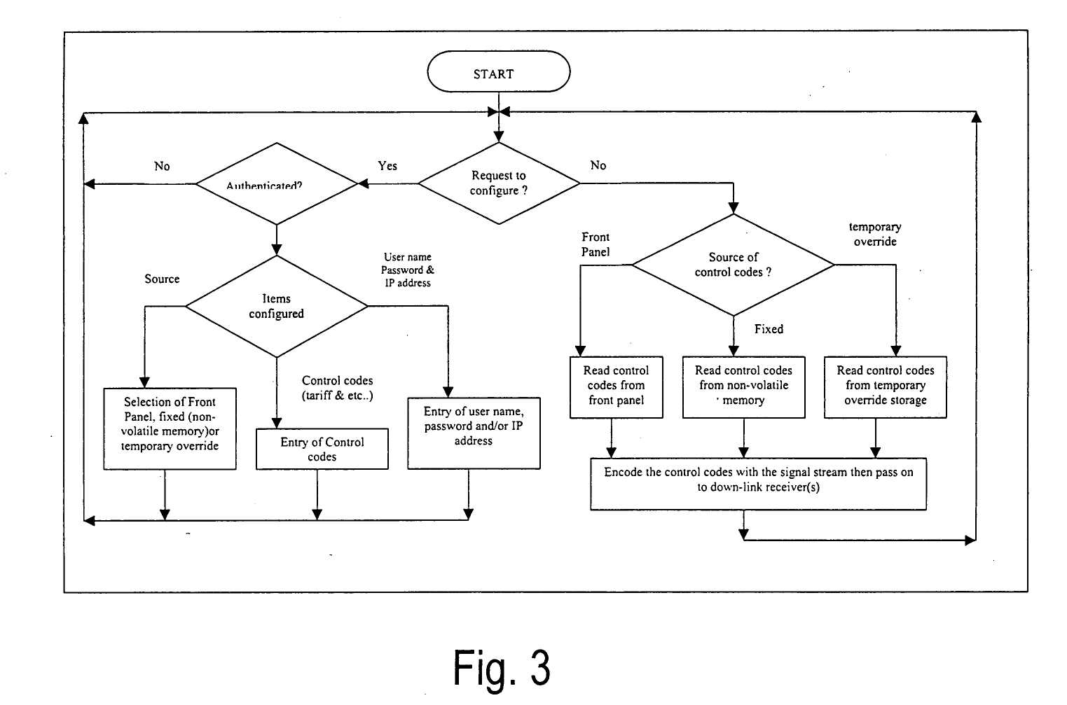

The transmitter encoder software flow control is illustrated in FIG. 3. Software control can be by authenticated or non-authenticated request to reconfigure. Authenticated request selects the items to be configured and depending upon the source, provides selection of front panel, fixed (non-volatile memory) or temporary override entry of control codes and also confirms the entry of the user name password and/or IP (protocol provider) address.

The non-authenticated configuration checks the source of the control codes and selects front panel fixed control codes or temporary override that reads control codes from temporary override storage. The software then encodes the control codes with a signal stream it passes through a down-link receiver or receivers.

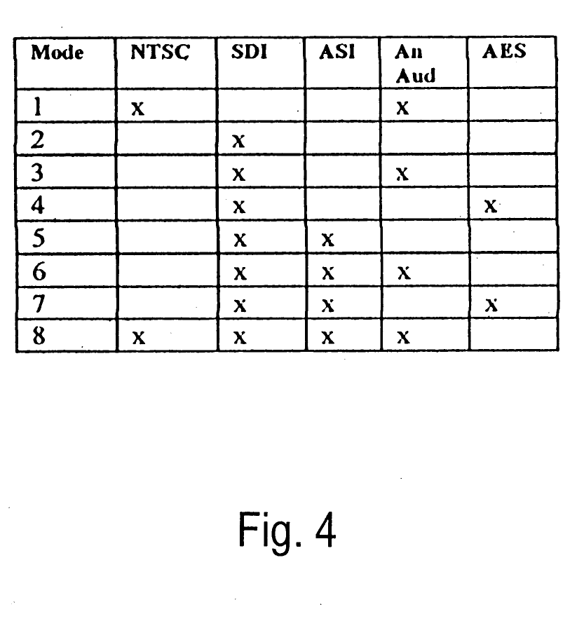

The modes that can be selected for tariff locking are illustrated in the chart of FIG. 4. Tariff locking can be achieved either by computer control by the software illustrated in FIG. 3 or by a front panel or internal manual selector switch control. The priority of manual/computer control is assigned via the software. The chart of FIG. 4 shows up to eight different modes that can be selected either by front panel switch or by software control through microprocessor 60. These outputs are locked to a regulatory tariff which can be NTSE and analog audio; SDI; SDI and analog audio; SDI and AED; SDI and ASI; SDI, ASI, and analog audio; SDI, ASI, and AES; and lastly SDI, ASI, analog audio, combined with NTSC format. Each of these outputs is locked to the regulatory tariff by the tariff locking control circuit 10 of FIG. 1 or in the more complex transmitter by the tariff select control circuit 30 of FIG. 2.

This invention is not to be limited by the embodiment shown in the drawings and described in the description which is given by way of example and not of limitation, but only in accordance with the scope of the appended claims.

What is claimed is:

1. A multi-format transmission system comprising;
a receiver for receiving inputs in multiple formats;
an input selector connected to said receiver for selecting inputs from said multiple formats to be delivered to a service;
a tariff select control for activating said input selector according to the tariff set for the service selected;
whereby the regulatory tariff for an output selected by a service is locked by said tariff select circuit.

2. The system according to claim 1 in which said multiple inputs are digital video inputs.

3. The system according to claim 2 in which said digital video inputs are selected from a digital video SDI and a digital video ASI.

4. The system according to claim 1 in which said tariff select control includes fixed regulatory tariff settings to insure the tariffs available to a customer are locked to a service selected.

5. The system according to claim 1 in which the output mode of said tariff select control is received from a microprocessor controller.

6. The system according to claim 1 in which the output mode of said tariff select control is received from an external multi-way switch.

7. The system according to claim 1 in which said input selector comprises separate a video input selector and a separate audio input selector.

8. The system according to claim 7 in which said separate video input selector receives analog video and digital video.

9. The system according to claim 8 in which said separate audio input selector receives analog audio and digital audio.

10. The system according to claim 9 in which said tariff select control activates said separate video input selector and said separate audio input selector to select either analog or digital video and analog or digital audio respectively.

11. The system according to claim 10 in which said tariff select control receives input from a microprocessor.

12. The system according to claim 10 in which said tariff select control receives input from an external multi-way switch.

13. The system according to claim 10 in which said tariff select control can select and lock up to approximately eight modes.

14. The system according to claim 13 in which said tariff select control up to eight different modes that are predetermined combination of NTSC, SDI, ASI, analog audio and AES.

15. The system according to claim 14 in which said eight different modes that can be selected are from the group comprised of NTSC/ANALOG AUDIO; SDI; SDI/ANALOG AUDIO; SDI/AES; SDI/ASI; SDI/ASI/ANALOG AUDIO; SDI/ASI/AES; and NTSC/SDI/ASI/ANALOG AUDIO.
